(19) United States
(12) Patent Application Publication
(10) Pub. No.: US 2014/0019884 A1
(43) Pub. Date: Jan. 16, 2014

(54) ENHANCED SYNCHRONOUS COMMUNICATION CHANNEL FOR INTERACTIVE COMMUNICATIONS BETWEEN PARTICIPANTS

(71) Applicants: Mark Andrew Dinan, Pasadena, CA (US); Jennifer Yun-Man Sun, Pasadena, CA (US); Timothy Howard Lee, Los Angeles, CA (US); James Mason Bower, Hondo, TX (US)

(72) Inventors: Mark Andrew Dinan, Pasadena, CA (US); Jennifer Yun-Man Sun, Pasadena, CA (US); Timothy Howard Lee, Los Angeles, CA (US); James Mason Bower, Hondo, TX (US)

(21) Appl. No.: 13/545,779

(22) Filed: Jul. 10, 2012

(51) Int. Cl. G06F 15/16; G06F 3/01

(52) U.S. Cl. 715/758; 709/206

(57) ABSTRACT

A system for enabling interactive communications between participants is described. The system includes a website, a first web-browser client, a second web-browser client, a synchronous communication channel, a spontaneous transmit message and a spontaneous receive message. The first web-browser client corresponds to a first participant accessing the website and receiving computer instructions from a first participant. The second web-browser client corresponds to a second participant accessing the website and receiving computer instructions from a second participant. The synchronous communication channel between the first browser client and the second browser client is configured to enable near real-time communications between the first participant and the second participant. The spontaneous transmit message is transmitted from the first web-browser client and the spontaneous transmit message received by the second browser client.

### FIELD OF THE INVENTION

The present invention relates to a system and method for transmitting and receiving messages via a communication channel. More particularly, the system and method relates to an enhanced synchronous communication channel for interactive communications between participants accessing the same website.

### BACKGROUND

It is common for websites to offer chat systems enabling visitors of the website to online chat with each other. A visitor can send text via the chat system, which results in the text being broadcast to the other website visitors chatting with the visitor. Some chat systems enhance this experience with emoticons, or with graphical avatars that enable each user to be represented by a graphical persona. Some chat systems extend the use of graphical avatars by providing a graphical environment where the avatars exist and interact with other avatars and with other objects in the graphical environment. For instance, the graphical environment may consist of a room or an outdoor space, thus giving the appearance that the avatars are walking around the room or outdoor space.

Chat systems enable users to communicate synchronously, including one-to-one, one-to-many, and many-to-many. Through the chat systems, text-based messages can be sent between two or more users in near real time. Chat systems are implemented as desktop applications and as online services. Desktop chat clients provide a wider range of functionality over web-based chatting systems. However, desktop chat clients require users to install the desktop chat client on their personal computer or device, and these chat clients run as a separate and stand-alone application. Thus, if a user was interested in chatting about a particular website, the user would be forced to open the web browser, open the chat client, and switch back and forth between the web browser and the chat client.

Online chatting services are provided by exclusive online chatting websites. A number of websites also provide browser-based chat services to enhance the user experience and interaction between members of the website, even though the primary content and service of the website is not online chatting. For example, the GMAIL website enables users to engage in text-based, voice, and video chat even though the primary service of the GMAIL website is an email service. Similarly, the FACEBOOK website includes a browser-based chat service that enables users to chat with their FACEBOOK contacts.

The user interface of these browser-based chat services typically include a displaying the messages that have been sent between chatting users, thus documenting the conversation or dialog between the chatting users. The text sent by each user is identified with the name, or some other identifier associated, with each user. The user interface also includes a text entry area, where the user can type and enter text to be communicated to the other users, and a send button or an alternative mechanism for transmitting a typed message. Finally, the chat service interface commonly includes a status associated with users, where the status indicates whether a particular user is online and available to chat, invisible, busy, away from the chat, offline, etc.

Most chat systems are configured to support the sending of static and animated emoticons. Sending an emoticon via a chat system results in the emoticon being displayed as part of the chat dialog between the users. Thus, present chat systems are limited to the communication of text-based messages which are rendered on the dialog frame of the chat system interface.

Voice and video chat also has become an integral part of videoconferencing software and services. Videoconferencing tools support sharing of a presenter's desktop with the other meeting participants, sharing of files, sketching tools, text-based chatting, and voice and video transmissions between the meeting participants. For example, the WEBEX Meetings software, developed by Cisco Systems, supports online meetings, while also including whiteboard sharing and remote control of the shared desktop/application. Remote control enables one or more of the remote meeting participants, other than the user sharing the desktop, to take control over the mouse to make edits or perform some other action, such as perform a demo. The limitation of videoconferencing software and services is that they require a session to be scheduled, and the sharing and whiteboard features are enabled as long as all users are engaged in the same sharing session. In addition, users must either install a desktop application, or they must log in to a designated website where the sole and primary purpose of the website is for the users to conduct an online meeting or participate in a whiteboarding.

Remote access and control of a computer is also a functionality commonly provided by remote IT support and monitoring tools. For example, the GOTOASSIST system enables two-way screen-sharing and remote control of the mouse and keyboard for remote IT support. Thus, a technical support user can initiate a screen-sharing session, view the screen of the remote user, and remotely control the mouse and keyboard to resolve the issue at hand. However, these systems require both the installation of a software application to enable the remote user to share the screen and to control the mouse and keyboard. In these systems, the remote user has permissions to view everything on the shared screen and to control the mouse and keyboard without restrictions.

Thus, there is a need for a system that enhances the interactivity of traditional chat systems of browser-based chat services, and that allows websites to leverage their chat systems to enhance the user experience.

### SUMMARY

A system for enabling interactive communications between participants is described. The system includes a website, a first web-browser client, a second web-browser client, a synchronous communication channel, a spontaneous transmit message and a spontaneous receive message. The website is includes at least one web page. The first web-browser client corresponds to a first participant accessing the website and receiving computer instructions from a first participant. The second web-browser client corresponds to a second participant accessing the website and receiving computer instructions from a second participant. The synchronous communication channel between the first browser client and the second browser client is configured to enable near real-time communications between the first participant and the second participant. The spontaneous transmit message is transmitted from the first web-browser client and is generated by the first participant that is accessing the same website as the second participant. The spontaneous transmit message is communicated from the first web-browser client to the second web-browser client using the synchronous communications channel. The spontaneous transmit message is received by the second browser client.

In one embodiment, the system includes a web server that hosts the website. The web server mediates the synchronous communications channel between the first web-browser client and the second web-browser client.

In another embodiment, the spontaneous transmit message includes a share message that communicates a URL of the web page displayed on the first web-browser client to the second web-browser client.

In yet another embodiment, the spontaneous transmit message includes a sprite message that draws a sprite at a set of coordinates on a first web page displayed on the first web-browser client, and draws the sprite at the set of coordinates on a second web page displayed on the second web-browser client.

In a further embodiment, the spontaneous transmit message includes a click message that executes a click operation at a set of coordinates on the web page displayed on the second web-browser client.

In a still further embodiment, the spontaneous transmit message includes a keystroke message that injects a series of keycodes into a text field on the web page displayed on the second web-browser client.

A computer-implemented method is also described. The method includes receiving a command via a chat system associated with a website, wherein the command created by a first participant viewing a first web page of the website on a first browser is received through a synchronous communication channel associated with the chat system. The method communicates the command to a second participant viewing a second web page of the website on the second browser, and the command is sent through the synchronous communication channel. The command is then received at the second browser. The command is executed on the second browser, wherein the command results in an action being performed outside of a client interface of the chat system on the second browser.

In one embodiment, the action includes loading a URL of a portion of the first web page on the second browser.

In another embodiment, the action includes drawing a sprite at a set of coordinates on the second web page displayed on the second browser.

In yet another embodiment, the action includes performing a clicking operation at a set of coordinates on the second web page displayed on the second browser. The clicking operation includes a mouse dragging operation, a left mouse click, a right mouse click, a middle mouse click, and a scrolling operation.

In a further embodiment, the action includes injecting a series of keycodes into a text field on the second web page displayed on the second browser.

### DRAWINGS

The present invention will be more fully understood by reference to the following drawings which are for illustrative, not limiting, purposes.

FIG. 1A illustrates a standard interface of an online chat system.

FIG. 1B illustrates a system diagram of clients connecting through the network to a web server hosting a website.

FIGS. 2A-2D illustrate a flow chart detailing the steps of sending a command from the sending participant to the receiving participant via the synchronous communication channel managed by the website server.

FIG. 3 illustrates an example of a sending participant sending a simple text-based message using a standard chat system.

FIG. 4 illustrates an example of a sending participant using the share command to share a web page with a receiving participant via the chat system in accordance with an embodiment.

FIG. 5 illustrates an example of a sending participant using the sprite command to draw an arrow on the web browser of the receiving participant in accordance with an embodiment.

FIG. 6 illustrates yet another example of a sending participant using the sprite command to draw a belt on the browser of the receiving participant in accordance with an embodiment.

FIG. 7 illustrates an example of the sending participant using the sprite command to draw an arrow on the browser of the receiving participant in order to show the receiving participant the location of the shopping cart on the web page, in accordance with an embodiment.

FIG. 8 illustrates an example of the sending participant using the sprite command, the click command, and the keycode command to perform a search for shoes on the browser of the receiving participant.

FIGS. 9A and 9B are screenshots of an online community where members can interact directly through online chat.

FIGS. 10A and 10B illustrate a special control box used by customer service representatives to chat with participants and which provides a number of tools for interacting with participants.

FIG. 11A illustrates the use of the sprite command to draw an arrow pointing to the “Info” button.

FIG. 11B illustrates the use of the sprite command to draw an arrow pointing to the “Guide” button.

### DESCRIPTION

Persons of ordinary skill in the art will realize that the following description is illustrative and not in any way limiting. Other embodiments of the claimed subject matter will readily suggest themselves to such skilled persons having the benefit of this disclosure. It shall be appreciated by those of ordinary skill in the art that the apparatus and systems described herein may vary as to configuration and as to details. Additionally, the methods may vary as to details, order of the actions, or other variations without departing from the illustrative method disclosed herein.

Embodiments described herein are directed to a system extending a browser-based chat system/service to include messages rendered outside of the chat system interface. Embodiments leverage the synchronous communication channel used by browser-based chat systems to transmit commands that enable the sharing of content and the execution of actions in the browsers of participants. The commands may be used to enable a sending participant to perform at least the following actions on the web browser of one or more receiving participants: share a web page, draw a sprite, perform a mouse click action, perform a keyboard action, share a pop-up window, or share a text-box. This is in contrast to traditional chat systems that enable users to send text-based messages and emoticons, but which are always displayed within the chat history frame.

For example, if User A, User B, and User C are browsing a shopping website, an embodiment enables the users to chat and to perform actions in the context of the shopping website. If User A wanted to solicit User B's and User C's opinion of a particular dress for sale on the website, User A can use the chatting system to share an image of the dress to Users B and C. That image may then appear on the screens of the three users. If User B wanted to highlight a weakness in the dress, User B may draw an arrow overlaid on top of the dress image, with the arrow being drawn on the screen of the three users. User C may then suggest a solution by pasting the image of a scarf that covers up the flaw, with the image of the scarf being drawn on the screen of the three users.

In another illustrative example, users may connect and initiate a chatting session as enabled by the chatting system provided by the website hosting the chatting service. Once the users have started a chat session, any of the users may then send standard text-based messages or command messages that perform an action that extends beyond the chat system interface of the chat participants.

From herein, “text-based message” will be used to refer to a plain text message sent via the chatting system, or sent via the synchronous communication channel. Text-based messages thus include plain text and emoticons.

From herein, “command message” will be used to refer to any message that results in an action being performed on the browsers of the other participants, including the rendering of content and actions performed outside of the chat system interface of the receiving participants.

A website will be used to refer to a set of related web pages containing content and being hosted by at least one web server. Finally, while examples of embodiments are described in the context of a website, such as a shopping website or a social networking website, alternative embodiments may also be used in virtual environments and other websites including a synchronous communication channel.

The command message includes spontaneous messages that are generated by at least two participants accessing the same website. Spontaneous messages include a spontaneous transmit message and a spontaneous receive message. By way of example and not of limitation, the spontaneous transmit message is transmitted from a first web-browser client and is generated by a first participant that is accessing the same website as a second participant. The spontaneous transmit message is communicated from the first web-browser client to the second web-browser client using a synchronous communications channel.

The spontaneous transmit message is then received by the second browser client and is also referred to as the spontaneous receive message. More particularly, the spontaneous receive message is received by the second web-browser client that is displayed on the second web-browser client. The spontaneous receive message may include an identifier for the first web-browser client, when the first browser client is accessing the same website as the second browser client.

A communications channel is a logical multiplexed connection used to convey a digital bit stream from one or more senders to one or more receivers. Synchronous communication refers to the bit stream flowing through the communication channel without appreciable delays or buffering, so messages are conveyed from sender to receiver with a delay between sending and receiving of no more than about 30 seconds. Longer delays break the sense that the communication is occurring in real time and can affect the experience of the participants. This level of responsiveness and lack of delay is also referred to as near real time. It is to be understood that while a delay in reference to about 30 seconds is described, the actual delay between sending and receiving, and its association with near real-time communication, may be greater than about 30 seconds or less than about 30 seconds.

A synchronous communication channel allows each participant's web browser to (1) send messages through the channel which are received in near real time by some or all the other participants in the channel; and (2) receive messages in near real time which have been sent by any of the other participants through the channel. It is to be understood that any method of creating, establishing, and maintaining a synchronous communication channel may be used with embodiments described herein.

The synchronous communication channel may be implemented using a peer-to-peer architecture, a client-server architecture, or some alternative software architecture. In a client-server architecture, each participant's web browser creates a connection to the website server, and the website server mediates the messages on the channel. A message received by the website server can then be broadcast to the web browsers of all the participants in the communication channel.

Additionally, the functions of web server may be embodied as cloud computing service or as a virtualized server. The virtualized server refers to a virtual machine that acts like a server with an operating system. The software or firmware that creates a virtual machine on the host hardware is called a hypervisor. With respect to cloud computing, there are various deployment models including public cloud, community cloud, hybrid cloud and private cloud implementations. The system architecture for cloud computing involves multiple components and support elastic provisioning. There are various service models for cloud computing includes Infrastructure as a Service, Platform as a Service, and Software as a Service.

The web browser can create a synchronous communication channel by using TCP sockets. For instance, HTML5 WebSockets may be used to implement a TCP socket from within a web browser. WebSockets provide for bi-directional, full-duplex communications channels over a single TCP connection. Browser plug-ins with TCP socket support may also be used to create a synchronous communication channel. For example, the JAVA plug-in and the FLASH plug-in include native TCP socket support, which the web browser can leverage to construct a TCP socket from the web browser to the website server. Alternatively, the XMLHttpRequest object, an API available in web browser scripting languages, may be used to create a communications channel. Specifically, Javascript and the XMLHttpRequest object may be used with Ajax and long polling techniques to simulate the behavior of a persistent bidirectional communications channel which satisfies the requirements of a synchronous communication channel.

It is to be understood that while various methods of implementing a synchronous communication channel were presented above, any other alternative method of implementing a synchronous communication channel may be used without departing from the spirit of embodiments.

In one embodiment, a user can invite other users to join a chat session. Users can join a chat or begin a group chat as is typically implemented in standard chat systems. For example, a first user may invite one or more other participants to join in a chat session. Alternatively, a list of a user's contacts or friends may be displayed while a users to visit a website, thus enabling the user to initiate chatting sessions by selecting users from the list of contacts. The chat system may include a status associated with each user, with the status indicating whether a particular user is online, offline, busy, away from computer, etc.

A unique identifier associated with each user may be used by the website hosting the chatting service to enable users to initiate chat sessions with other participants, and to manage synchronous communication channels between chatting participants. In one embodiment, a login system may be used by the website to track users currently visiting the website, and subsequently used to enable users to initiate chat sessions with other logged-in users. The website may provide its own login system, or it may use a third party login system. Examples of third party login systems include the FACEBOOK login system, the OPENID login system, the GOGGLE account login system, the TWITTER login system, the YAHOO login system, and the WINDOWS LIVE login system, among others. Alternatively, a user may be prompted to provide a one-time-use username. The website may also automatically create a one-time-use username which is assigned to the user when the user first visits the website, such as a guest account. Regardless of the type of login system used or the manner in which usernames are assigned, what is important is for the website to be able to identify the various users currently visiting the website, in order to enable the website server to manage the synchronous communication channels between participants.

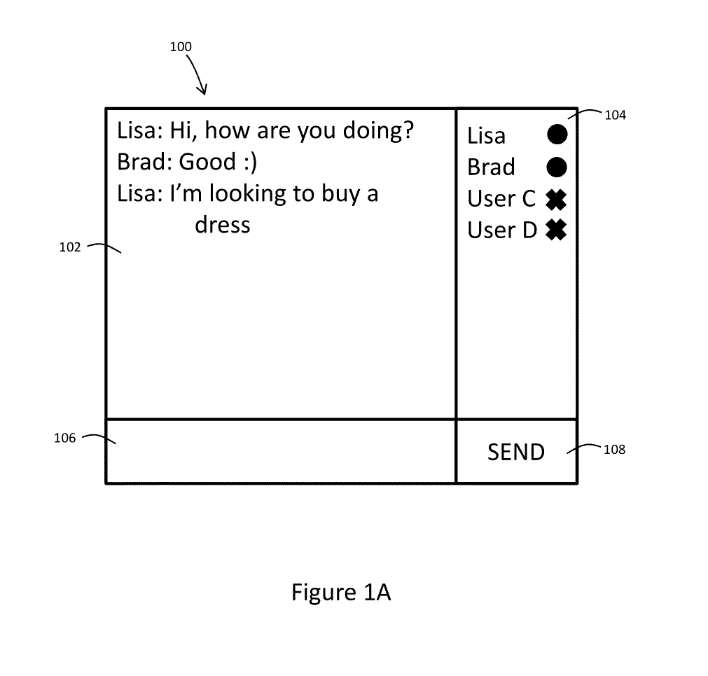

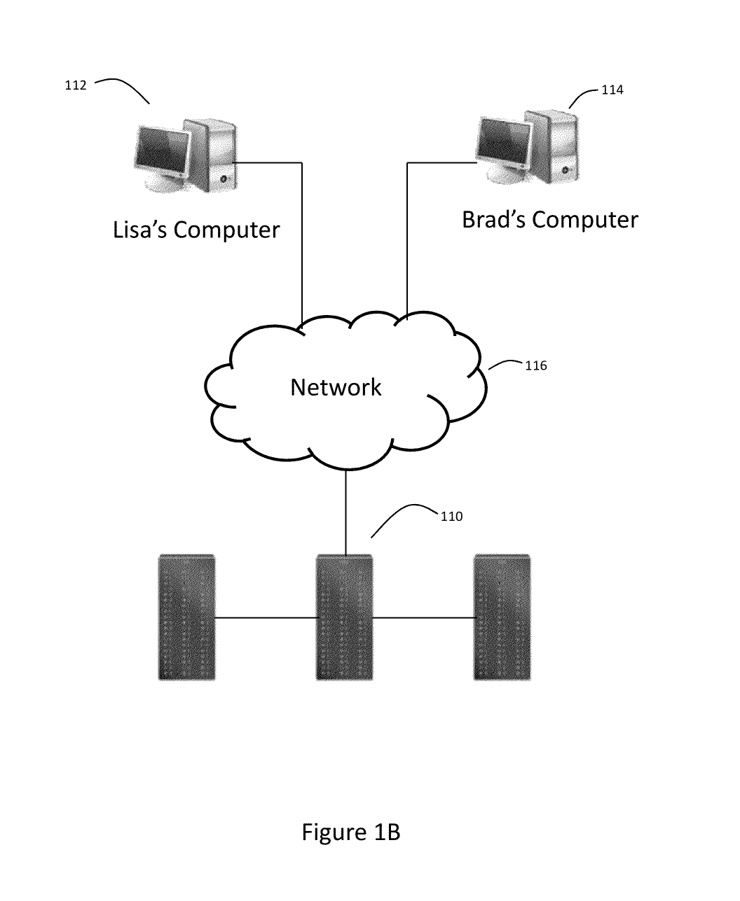

FIG. 1 illustrates a standard interface 100 of a chat system. The interface 100 includes a conversation box 102 displaying the messages that have been sent by the various chat participants. The status box 104 displays the list of contacts and friends, along with a status icon indicating whether users are online or offline. The interface also includes a text input box 106 where each participant can type in text to be sent as a message to the other participants by pressing the send button 108.

FIG. 1B illustrates a system diagram of how the participants from FIG. 1A can connect to a server hosting a website that includes a chat system. The website server(s) 110 hosts a website being visited by a first client device 112 and a second client device 114, the website including a chat system. Client devices 112 and 114 connect to the website server 110 via network 116. The network may be the Internet, or any other type of network, such as a LAN, a WAN, a CAN, a MAN, etc.

Rather than only sending and receiving text-based messages and emoticons which are displayed within the conversation box 102, embodiments enable users to share content and execute commands on the browser of other participants which are executed outside of the chat system interface on the receiving participant's browser. For example, a command message may be entered directly into the text input box 106, and rather than the command being interpreted as plain text and being displayed on the conversation box 102 of the receiving participant, the command is parsed and executed to perform an action. The action may include sharing a URL, drawing a sprite, performing a click action, performing a keyboard action, displaying a pop-up window, or displaying a text box. It is noted that embodiments are not limited to sharing and performing an action strictly outside of the boundary of the conversation box 102. For example, embodiments may enable a user to draw an arrow sprite pointing to the status box 104, or even use a combination of click actions and keyboard actions to inject text into the text input box 106 of the receiving participant.

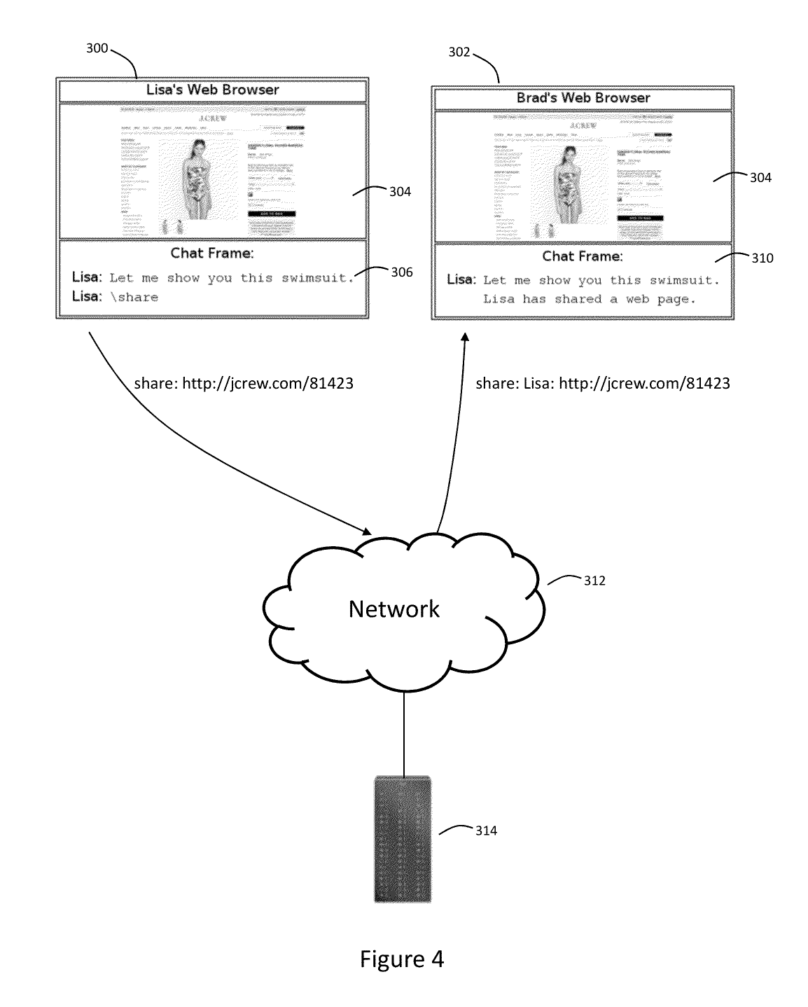

As noted above, the command messages may be entered on the text input box 106 of the chat interface provided by a website, with the chat interface thus acting as a command-line interface. The commands may be specified using any type of syntax, which when processed (client-side or server-side) identify the text entered as a command rather than as a plain text-based message. In one embodiment, a leading character or a sequence of characters may be used to specify special commands that are not to be interpreted as text-based messages. For example, in reference to FIGS. 4-8, a backslash “\” is used to denote special commands. For instance, the following would be interpreted as a special command for drawing an arrow sprite on the web browser of a receiving participant: “\sprite:arrow.png:200,125”. This command indicates that the sender wants to send a sprite message which contains a graphic titled “arrow.png”, with the sprite positioned at coordinates x=200 and y=125. A sending participant may also share his/her screen by typing “\share” in the text input box 106. It is to be understood that any other leading character or alternative syntax may be used to denote the special commands. In addition, while a particular set of keywords is used herein to describe the commands, alternative embodiments may use other keywords to perform the same actions.

In one embodiment, a graphical interface may be provided for entering commands. The graphical interface may be used instead of the command-line interface or in combination with the command-line interface. In the graphical interface, the interface may provide menu options, a plurality of buttons, or a plurality of widgets, enabling users to specify a command message. The graphical interface has the advantage of not requiring users to memorize the specific keywords and syntax for the various commands. For example, rather than drawing a sprite by typing “\sprite:arrow.png:200,125” in the text input box 106, the graphical interface can provide the user with the ability to browse through a library of available sprites, select a sprite with the mouse or keyboard, and drag with the mouse the sprite to the desired location on the web page.

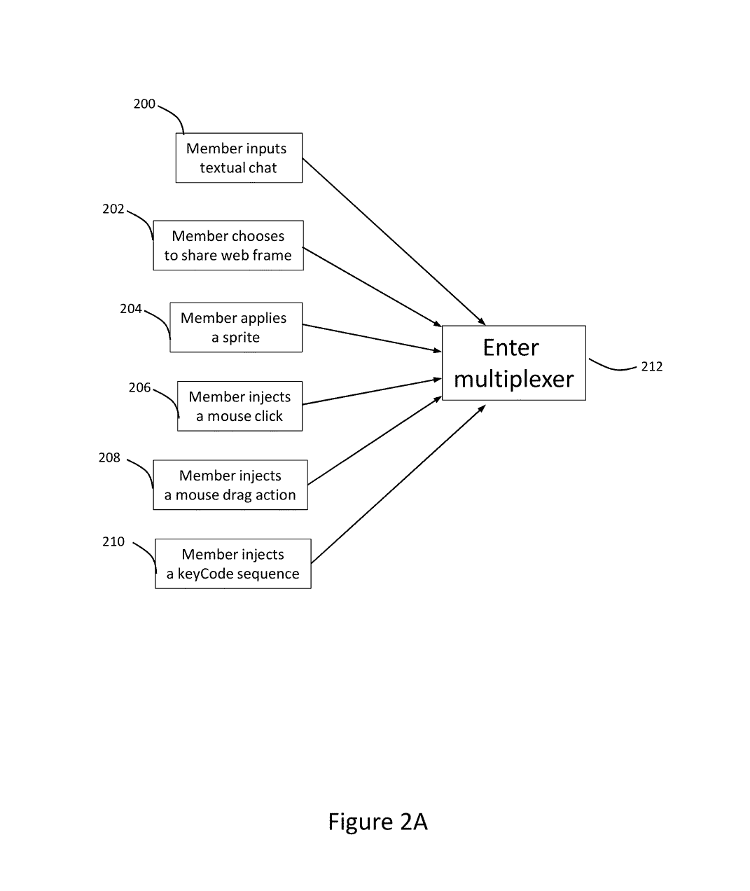

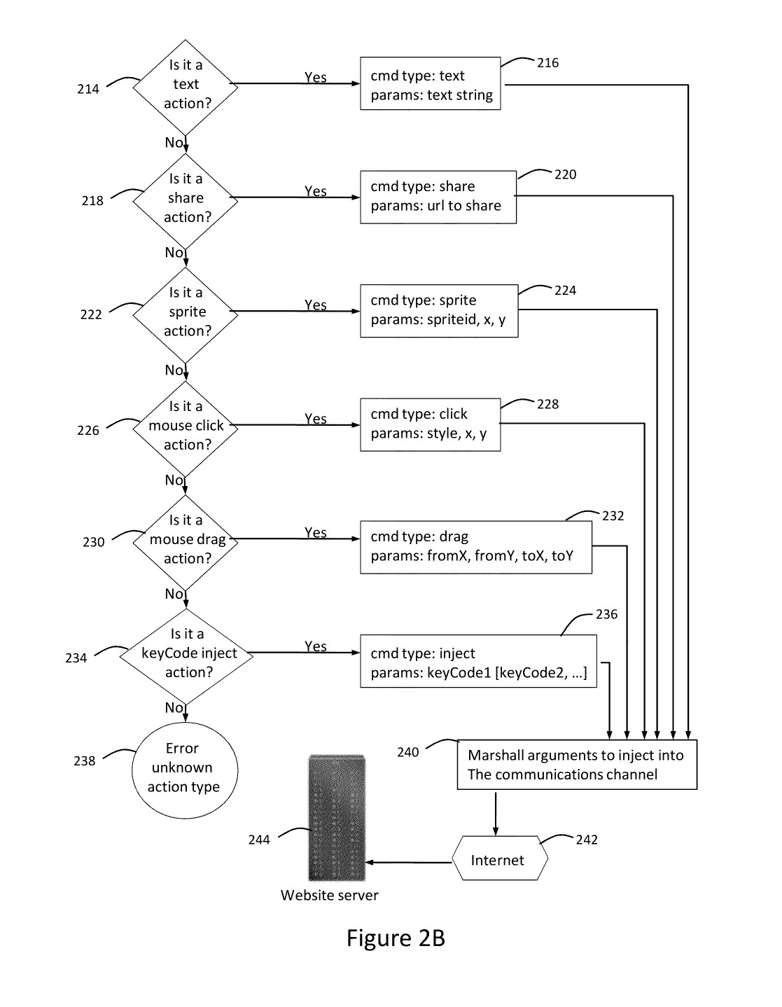

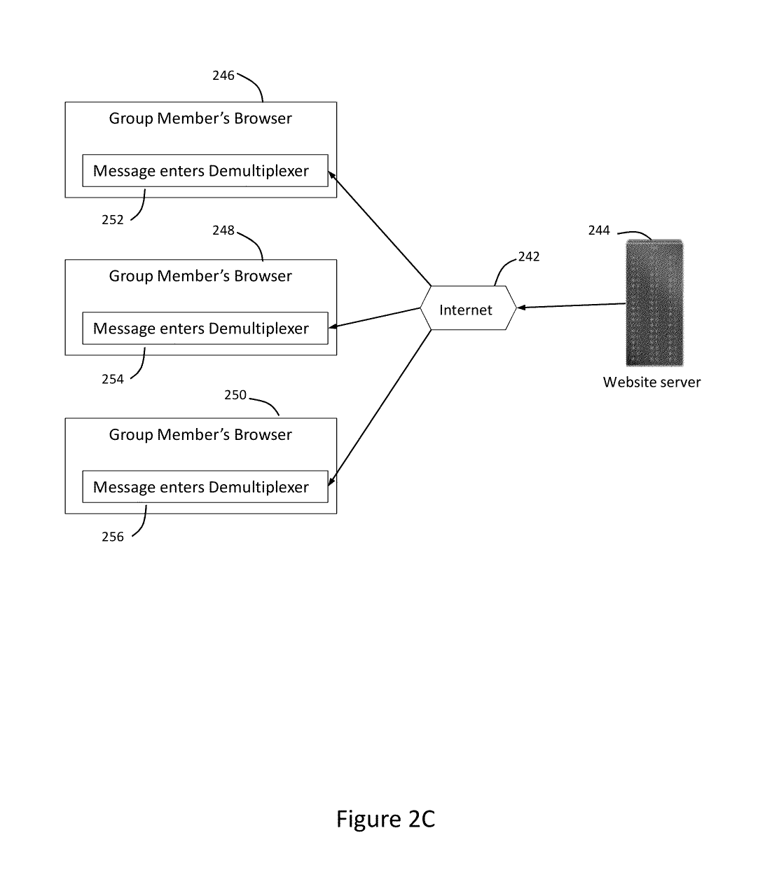

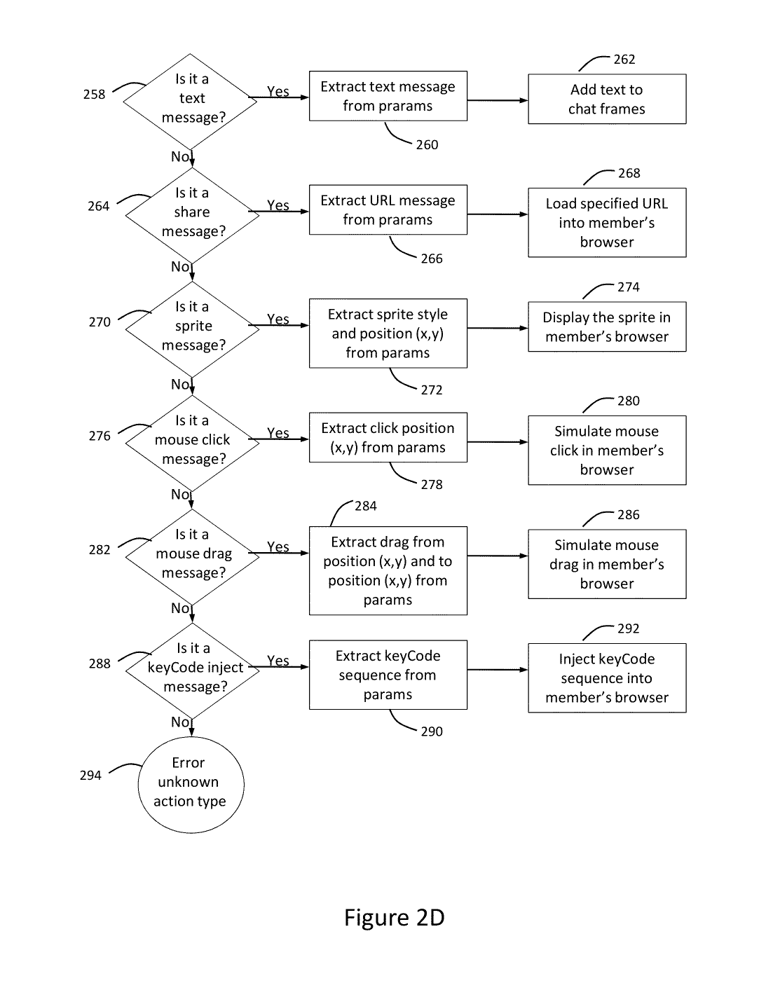

FIGS. 2A-2D illustrate a flow chart detailing the steps of sending a command from the sending participant to the receiving participant via the synchronous communication channel managed by the website server. FIGS. 2A-2D illustrate the processing of command messages using a command-line interface. However, alternative embodiments using a graphical interface may also follow a process flow similar to that illustrated in FIG. 2.

As shown in FIG. 2A, a participant may perform any of actions 200-210, resulting in a command being communicated to one or more other participants. The actions include inputting a textual chat 200, choosing to share an element of a web page 202, applying a sprite 204, injecting a mouse click 206, injecting a mouse drag action 208, and injecting a keycode sequence 210. The corresponding action then enters a multiplexer 212. The multiplexer parses and processes the text entered by the user, and creates an appropriate command with parameters for execution on the receiving participant's browser. As shown in FIG. 2B, step 214 checks whether the text is a text action. A text action simply consists of a plain text-based message being communicated. In step 216, the command type is set to simple text, with the parameters being the actual text string. If it is not a text action, then the text is a command message.

Step 218 checks whether the action is a share action. If true, then step 220 sets the command type to “share” and sets the parameter to the URL to share with the receiving participants. Step 222 checks whether the action is a sprite action, with step 224 setting the command type to “sprite” and setting the parameters to include the sprite ID and the position coordinates of the sprite. Step 226 checks to see if the action is a mouse click action. If step 226 is true, then step 228 sets the command type to “click” and sets the parameters to include a style of click and the coordinates of the click. Step 230 checks whether the action is a mouse drag action, with step 232 setting the command type to drag and setting the parameters to include the originating drag coordinates and the ending drag coordinates. Finally, step 234 checks whether the action is a keycode inject action. If true, step 236 sets the command type to inject, and the parameters are set to the plurality of keycodes typed by the user.

If the system is not able to match an action type to the action, then step 238 indicates an error. For steps 216, 220, 224, 228, 232, and 236, after the command type and the parameters have been set, step 240 formats the arguments as needed and transmits the result through the communication channel. The data is communicated via network 242 to the website server 244, which mediates the communication channel. The data is then communicated via network 242 to the browsers of the receiving participants 246, 248, and 250, as shown on FIG. 2C. Each browser includes a demultiplexer 252, 254, and 256 which extracts the data received.

In embodiments that include the graphical interface for defining the command messages, the graphical interface may automatically convert the user's graphical input into a text-based command message. For instance, a user sharing a sprite may first select a sprite from a library of sprites, and then drag and drop the sprite to the desired location. The present system may then retrieve the sprite ID of the sprite selected by the user, and save the location where the user dropped the sprite. The sprite ID and the location can then be passed to the multiplexer for processing as illustrated in FIG. 2A.

In FIG. 2D, step 258 checks whether the message received is a simple text-based message. If the message is a simple text-based message, then step 260 extracts the text message from the parameters, and step 262 adds the text to the participants' conversation box 102. Step 264 checks whether the message is a share message. If true, then step 266 extracts the URL from the parameters, and step 268 loads the specified URL to the web browsers of the receiving participants. Step 270 checks whether the message is a sprite message. If true, step 272 extracts the sprite style and the sprite position, and step 274 displays the sprite in the browser of the participants at the specified target position.

Step 276 checks whether the message is a mouse click message. If the message is a mouse click message, step 278 extracts the click position from the message, and step 280 simulates a mouse click in the browsers of the receiving participants. Step 282 checks to see if the message is a mouse drag message. If true, step 284 extracts the originating position and the ending position of the mouse drag action. Step 286 then simulates a mouse drag in the browsers of the receiving participants.

Step 288 checks whether the message is a keycode injection message. If true, step 290 extracts the keycode sequence from the message, and step 292 injects the keycode sequence into the browsers of the receiving participants. Finally, if the message type cannot be determined, step 294 may issue an error.

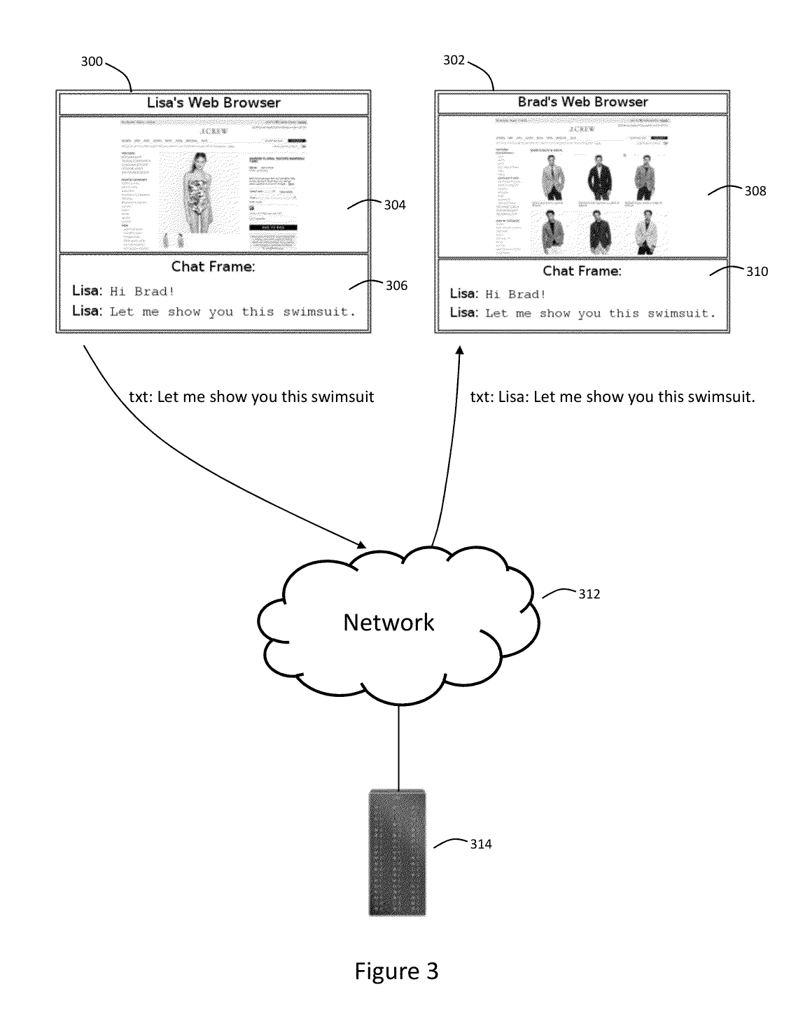

FIG. 3 illustrates an example interaction between a first browser 300 (“Lisa's Web Browser”), running on a first client device, and a second browser 302 (“Brad's Web Browser), running on a second device. The first browser 300 includes a web page 304 and a chat frame 306. Similarly, the second browser 302 includes a web page 308 and a chat frame 310. In the present example, the first browser and the second browser are accessing the same website, i.e. visiting the same domain, even though they may be accessing different web pages within the same website. For example, the first browser 300 illustrates Lisa viewing women's swimsuits, while the second browser 302 illustrates Brad viewing men's clothing.

The chat frames 306 and 310 are also used to refer to the chat interface. Chat frames 306 and 310 are illustrated as being contained within a separate frame from web pages 304 and 308. However, it is to be understood that the chat interface may be displayed within the web pages 304 and 308 without being contained within a separate frame. For example, the chat interface may be displayed along the bottom portion of the web page, on a separate column on the web page, etc. The chat interface may also be displayed on a separate window.

The chat frames 306 and 310 need not be positioned at the bottom of the web browser. Alternatively, the chat frame may be positioned along the left side of the web browser, along the right side of the web browser, or along the top of the web browser. The chat frame may also enable the user to move and drag the chat frame to a different position, or select a preferred position on the web browser. The chat frame may also provide the option to float the chat interface within the web page. The chat frame and the chat interface may provide a configuration of settings menu enabling the user to customize the position and other settings of the chat frame.

The chat frames 306 and 310 illustrate the conversation between Lisa and Brad. As described above, a synchronous communication channel enables the chat communication between the first browser 300 and the second browser 302. The website server 314 manages the synchronous communication channel and the transmissions between the first browser 300 and the second browser 302. FIG. 3 illustrates the text “Let me show you this swimsuit” being communicated from the first browser 300 to the second browser 302. Since this text does not include a special character or any syntax characterizing the text as a command message, the text “Let me show you this swimsuit” is displayed on the chat frame 306 and 310 of both browsers. In particular, FIG. 3 illustrates the execution of steps 200, 214, 216, and 258-262.

FIG. 4 illustrates the use of the share command. Specifically, Lisa types the command “\share” in the text input box of the first chat frame 306. The share command, when used without any further arguments, sends to the receiving participants the current web page being viewed by the sending participant. In this case, the web page 304 with the swimsuit is shared by Lisa with Brad, resulting in web page 304 being displayed in the second web browser 302. As noted above, when it is detected that the shared command is being used, a URL is extracted and passed to the receiving participants as a parameter. However, the shared command can also enable a sending participant to select any element of a web page, with the URL of the selected of element being sent to the receiving participants.

FIG. 4 illustrates that using the share command “\share” without any further arguments automatically extracts the URL of the web page currently viewed by the sending participant. After the URL is loaded on the second browser 302, a status message may optionally be displayed on the chat frame 310 explaining the result of the command (“Lisa has shared a web page”). If an error had occurred, then an error message may optionally be displayed on the chat frame 310.

The arguments associated with the share command may be specified using various techniques. For example, after entering the command “\share” on the text input box, the user may automatically be prompted to select, with an input device, the section of the web page to share with the receiving participants. When manually selecting, such as with the mouse or keyboard, a portion of a web page to share, the corresponding sections may be highlighted as the user moves the cursor over them so as to facilitate the element selection process. Any element from the DOM tree of a web page, or a browser plug-in, may be selected for sharing with receiving participants. For instance, in further reference to FIG. 4, Lisa may have entered the share command and then clicked on the image of the swimsuit, resulting in only the URL of the swimsuit being shared with Brad.

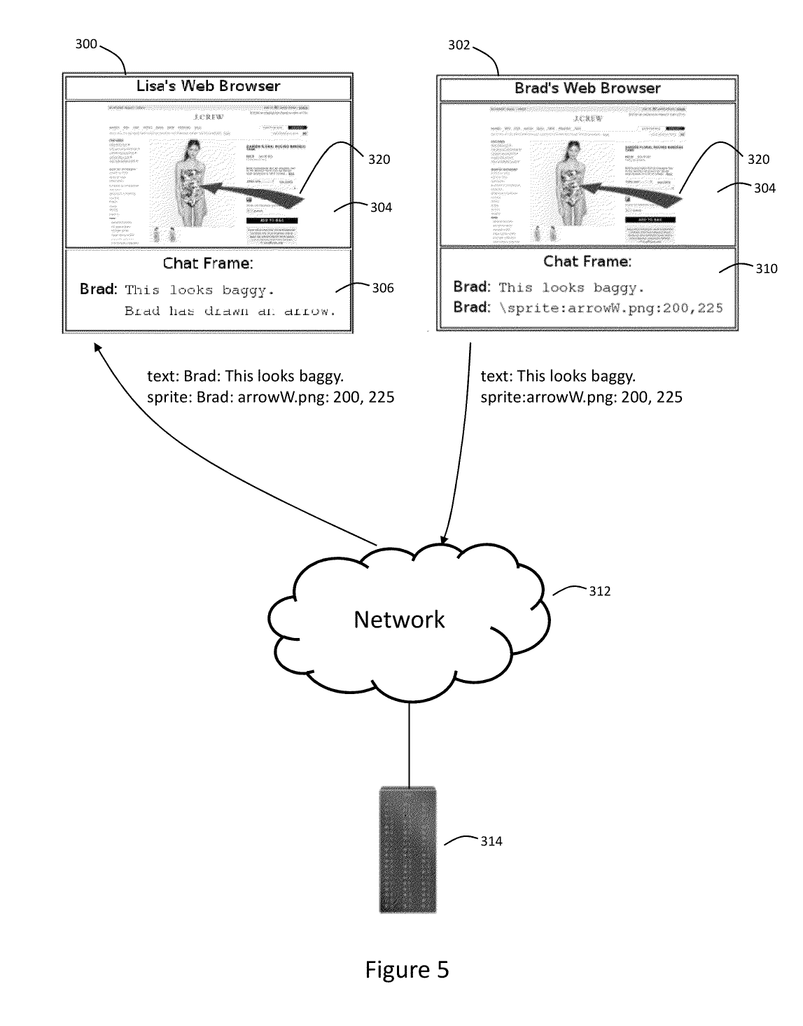

FIG. 5 illustrates the use of the sprite command. Brad comments on the swimsuit, shared by Lisa as shown in FIG. 4, by indicating that a particular portion of the swimsuit looks baggy. Brad then enters the command “\sprite:arrowW.png:200,225”, with the sprite command accepting two arguments: (1) the name of the sprite, and (2) the display coordinates of the sprite. The command results in the arrow sprite 320 being drawn on the web page being viewed on the first browser 300 and the second browser 302. The chat frame 306 shows a status message indicating that an arrow was drawn by Brad.

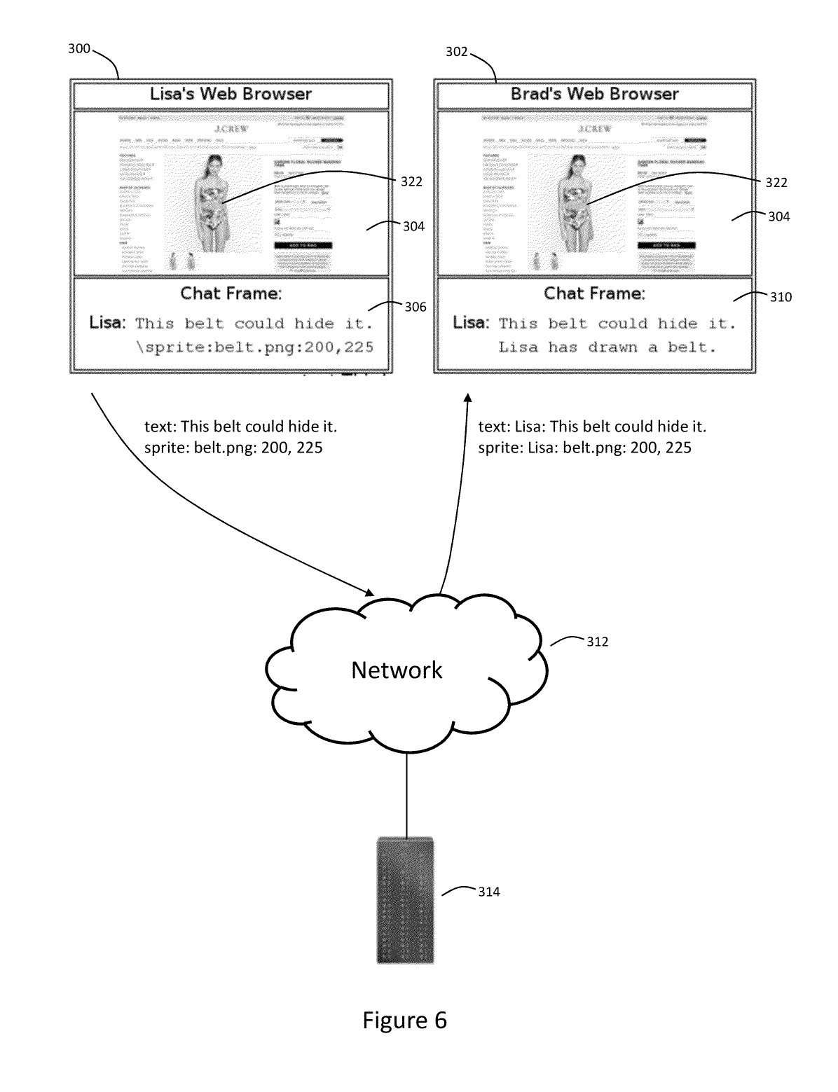

FIG. 6 illustrates Lisa responding by drawing a belt sprite 322 on the shared web page 304, resulting in belt sprite 322 being drawn on both the first web browser 300 and the second web browser 302. While FIG. 6 shows the arrow sprite 320 being replaced with the belt sprite 322, in an alternative embodiment drawn sprites may remain on the web page based on a number of conditions. These conditions may be specified by the website, by the chat system, or by the participants. For example, in one embodiment only one sprite may be displayed at a time, with any previously drawn sprite being automatically deleted. Alternatively, the participants may also select and delete a sprite at any time. For instance, if Lisa wanted to draw the belt sprite without having the arrow sprite on the way, then Lisa may select and delete the arrow sprite using a command entered into the text input box or by using the mouse or keyboard. Sprites may also be deleted only when a participant exits the website, or when a participant visits a different web page within the website.

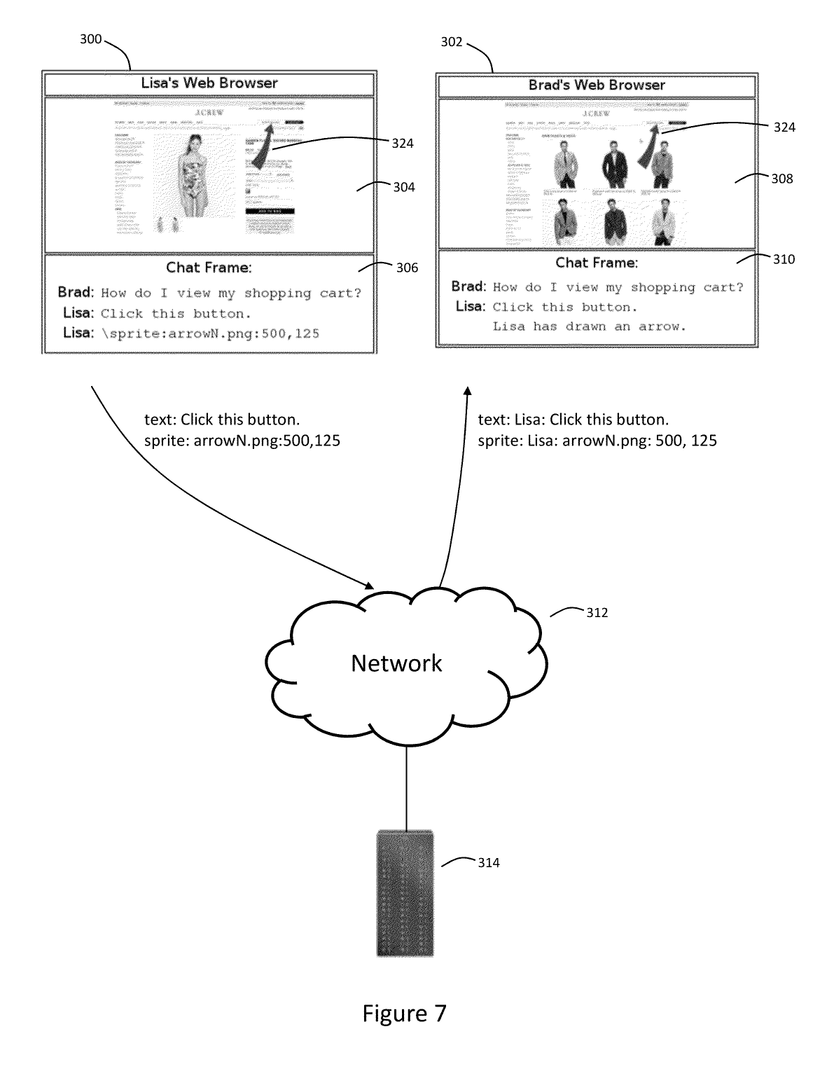

FIG. 7 illustrates a further interaction between Lisa and Brad as enabled by embodiments. Brad asks Lisa how to view his shopping cart. Lisa responds by indicating with an arrow 324 the location of the shopping cart button. Lisa uses the sprite command to draw the sprite “arrowN.png” at the coordinate (500, 125). The arrow sprite 324 is drawn on web pages 304 and 308 on the first web browser 300 and the second web browser 302.

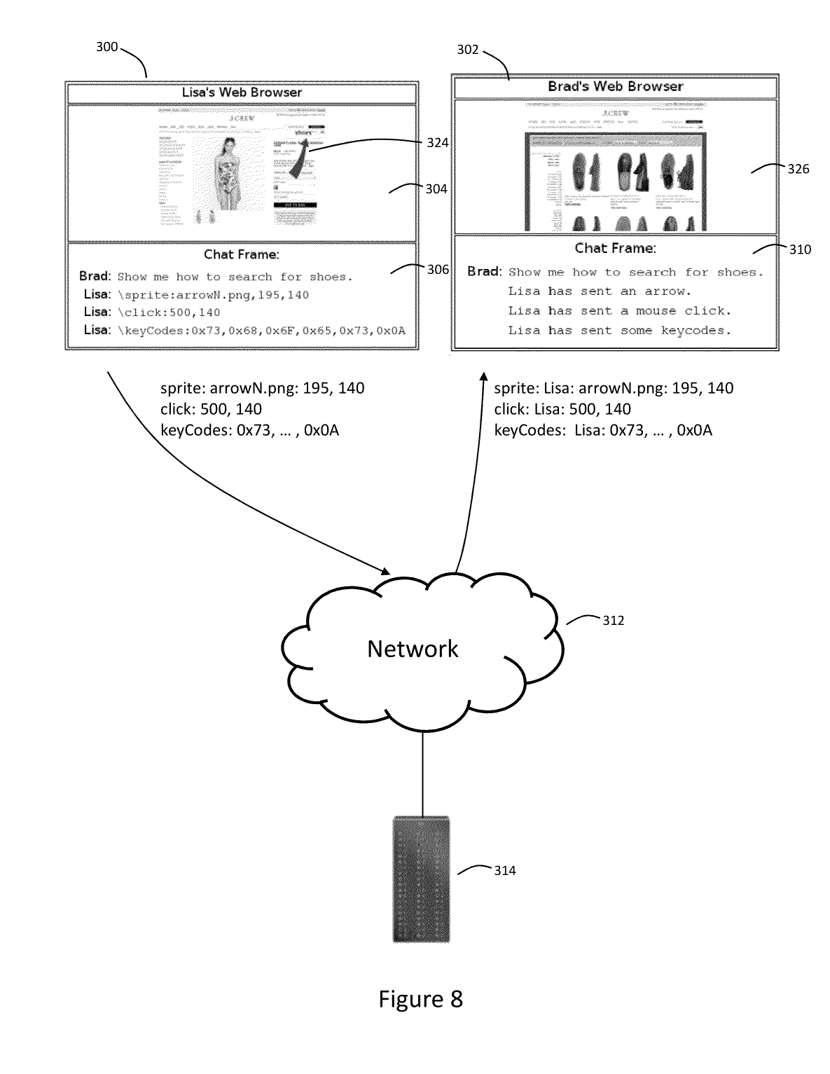

FIG. 8 illustrates a combined use of the sprite command, the click command, and the keycodes command. Brad asks Lisa to show him how to search for shoes. In response, Lisa first uses the sprite command to send an arrow 324 pointing to the search field of web page 308. Lisa then uses the click command to send a mouse click to Brad's browser, forcing a click in Brad's browser inside the search field. Lisa specifies the mouse click by entering the command “\click:500,140” on the text input box of the chat frame 306, where “\click” indicates the use of the click command, and “500,140” indicates the coordinates of where to perform the mouse click. Lisa then sends virtual keystrokes to Brad's browser using the keycode command in order to inject the search term “shoes” into the search field on web page 308 displayed on Brad's browser 302. The final keycode entered by Lisa is a carriage-return, which results in Brad's browser 302 performing a search for shoes and returning a web page 326 with the shoes search results. The result of each of the commands may optionally be indicated to Brad in the chat frame 310, i.e. “Lisa has sent an arrow”, “Lisa has sent a mouse click”, and “Lisa has sent some keycodes”.

FIG. 8 in particular shows that the use of the share command does not result on a shared screen between users. That is, the shared command does not force a sharing session with the receiving participants. A sending participant may share a particular web page, or a portion of a web page, with receiving participant's. However, this action does not result on control being surrendered to the other participants. While the share command does send the shared web page to the receiving participants, at any point afterward any of the participants (including the sending participant) may change the web page they are currently viewing, with this change not affecting the web page being viewed by the other participants. For instance, if Brad received the shared web page with the swimsuit, but was not interested in providing feedback, Brad may have pressed the back button (or performed an alternative action) on his browser in order to go back to viewing the web page he was originally viewing.

Parameters associated with the share command may enable users to customize the behavior of the sharing function. In one embodiment, a sending participant may specify that the web page to be shared is to be viewed on the browser of the receiving participants for at least a period of time. For example, Lisa may specify that the shared webpage is to be displayed on Brad's browser for at least one minute. The parameters may also enable the sending recipient to customize viewing notifications associated with the shared URL, such that when Brad stops viewing the web page shared by Lisa, a notification is sent to Lisa's web browser indicating that Brad is no longer viewing the shared web page. This status message may be displayed on the chat frame or in some other location within the web page being viewed by Lisa. The status message may also be displayed outside of the chat frame, on a pop-up dialog, or as a message floating in the web page.

In one embodiment, the shared web page may be displayed on a separate window. For instance, sending the shared command may result in the receiving participant's web browser opening a new browser window with the shared URL. This approach has the benefit of preserving the original web page that the receiving participant was viewing prior to the shared command.

The sprite command may be used to send images to participants at any time during a chatting session between participants, even if no web page was shared between the participants. For example, in FIGS. 3-5, the sprite command is explained in the context of Lisa and Brad drawing sprites on a shared web page in order to make comments on the swimsuit being viewed by both participants. However, the sprites may be sent at any time between participants. For instance, Lisa may send another arrow while Brad is browsing the shoes in FIG. 8. All that is needed for Lisa to send a sprite to Brad's browser is for Lisa and Brad to be engaged in a synchronous communication.

In one embodiment, sprites may be selected from a library of sprites. The library of sprites may be stored on the client server or they may be stored on the website server. A sprite may also be loaded by providing the URL of the sprite, by loading the URL from a local drive, by loading the URL from a remote drive, or by allowing the sending participant to draw the sprite.

The graphical interface for specifying command messages may provide participants with a set of drawing tools, enabling participants to draw shapes using lines, curves, rectangles, polygons, circles, ellipses, a color-fill tool, a paintbrush tool, an eraser tool, a freeform tool, etc. The chat system may be configured to send drawn sprites, as they are being drawn, to the receiving participants. Alternatively, the chat system may enable participants to draw and edit a sprite, requiring participants to press a send button after the sending participant is done making edits to the sprite. After a sprite is drawn, any of the participants may also edit a drawn sprite by deleting it, resizing it, cropping it, changing its color, changing its position and orientation, etc. The chat system may also enable users to edit animations associated with the sprite, such as blinking, fading, moving around the screen, etc.

In an embodiment, participants may be enabled to block certain types of content. A chat configuration menu may enable participants to configure the type of content that may be delivered to the user and content which may be blocked. For instance, a first participant may accept all content, while a second participant may specify that sprites are to be blocked. If a participant attempts to send content to a second participant who has specified that the particular type of content sent is to be blocked, then a notification may optionally be sent to the sending participant that the content sent was blocked. The receiving participant may also be notified when there was an attempt to send content that is blocked, per the participant's settings. In this case, the receiving participant may be given the choice to allow the sent content or to continue blocking the content.

While FIG. 8 illustrates the keycode command requiring the user to enter actual keycodes associated with letters and numbers, alternative embodiments may enable participants to specify keycodes by typing plain text. For example, the plain text may be entered into the text input box of the chat interface. When entering the keycode command, a pop-up window or dialog box may also prompt the user to enter the text to be entered into the field of the receiving participants. The keycodes command can also enable participants to specify special control keys and control sequences, including ctrl, shift, tab, caps lock, etc. Finally, in embodiments with a graphical interface, the user may specify with the mouse (or with an alternative input device) the field where text is to be entered on the receiving participants' web page.

As noted above, mouse actions (or input device actions) include performing a mouse click and performing a mouse drag operation. The command message for the mouse click enables a sending participant to specify whether the mouse click is a left click, a right click, a middle click, or a mouse scrolling. The click command may also enable participants to specify double clicks, a mouse movement over a certain portion of a web page, and a mouse gesture.

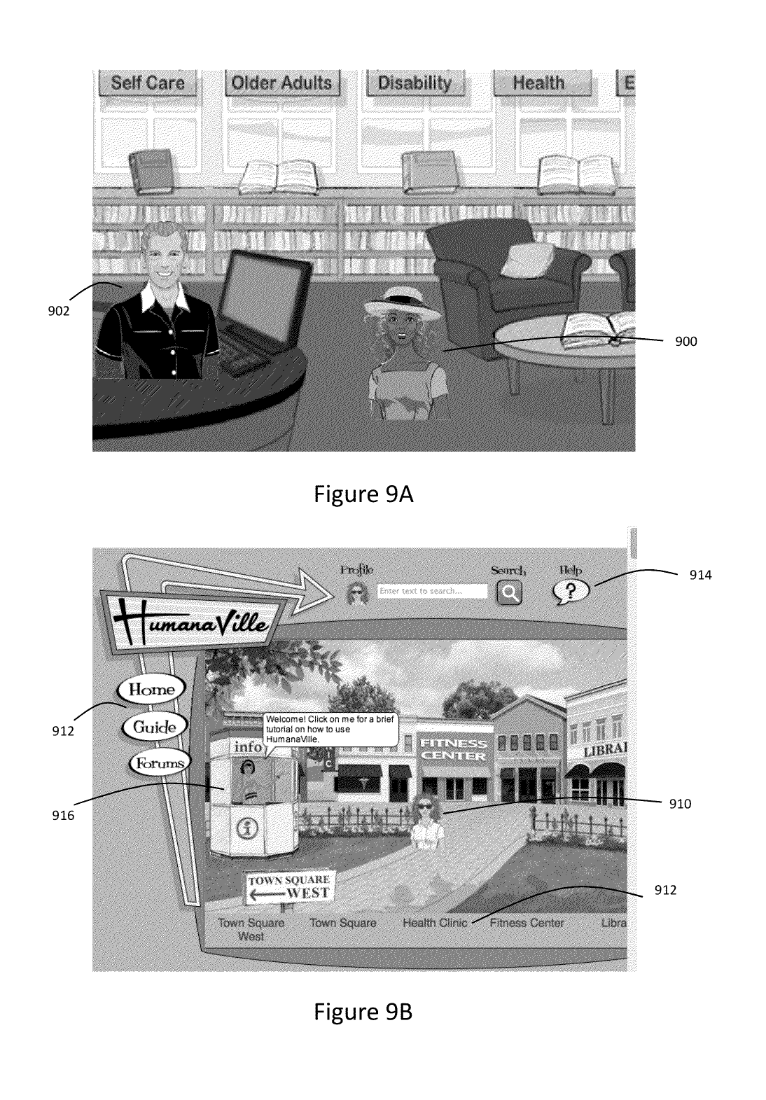

In an alternative embodiment, the chat system may enable participants to record one or more actions, which are then transmitted as a single command. That is, the chat system may enable participants to define macros which can be transmitted to receiving participants as a single command, or which may be saved for future use. For instance, the three operations in FIG. 8 (sprite command, click command, and keycode command) may be saved as a macro by a participant, enabling the participant to send the macro as a single command, and to enable the participant to reuse the macro with other receiving participants. The use of this macro functionality may be particularly beneficial for customer service representatives as further discussed in reference to FIGS. 9-11.

FIG. 9A illustrates a screenshot of an online community where members can interact directly through online chat. In particular, FIG. 9A illustrates an online community where members can interact with other members to discuss health topics, and where customer service representatives (CSRs) can answer member questions and assist members in learning to use the online community. The screenshot shows an avatar 900 associated with a member of the community, and a CSR avatar 902 associated with a CSR of the online community. FIG. 9B illustrates the main screen of the online community as seen by a member after logging in. Avatar 910 is associated with the logged in member. The main screen also includes menu options 912, a help menu 914 and an info booth 916 which can be used to chat with a CSR to ask questions about the content and controls of the online community.

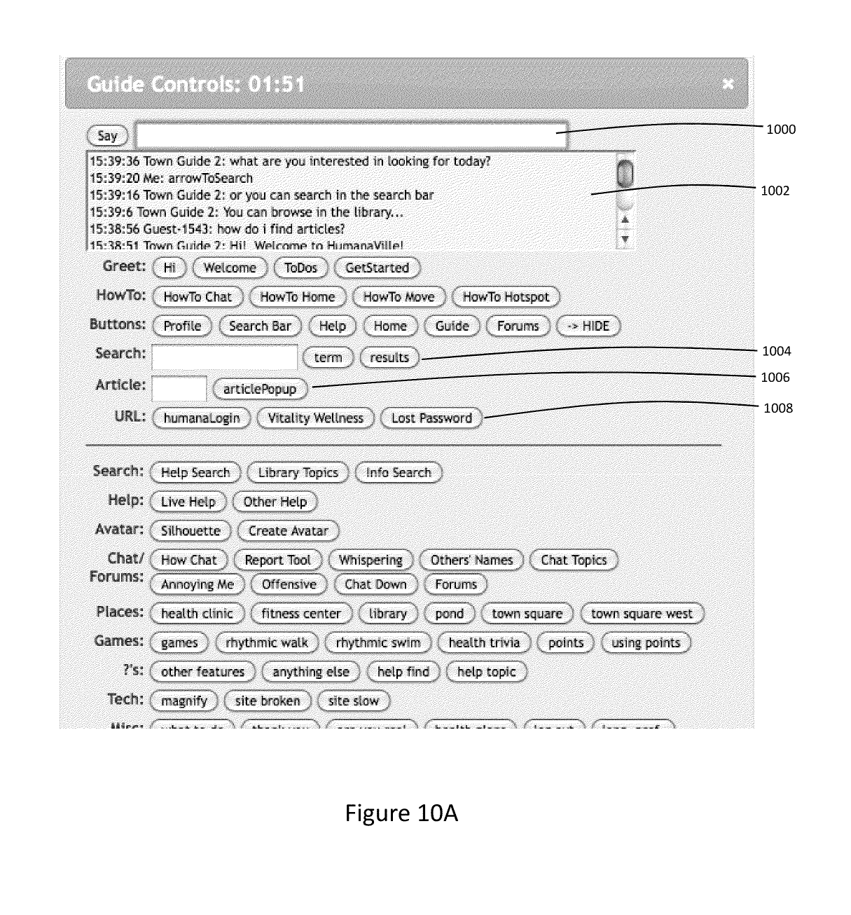

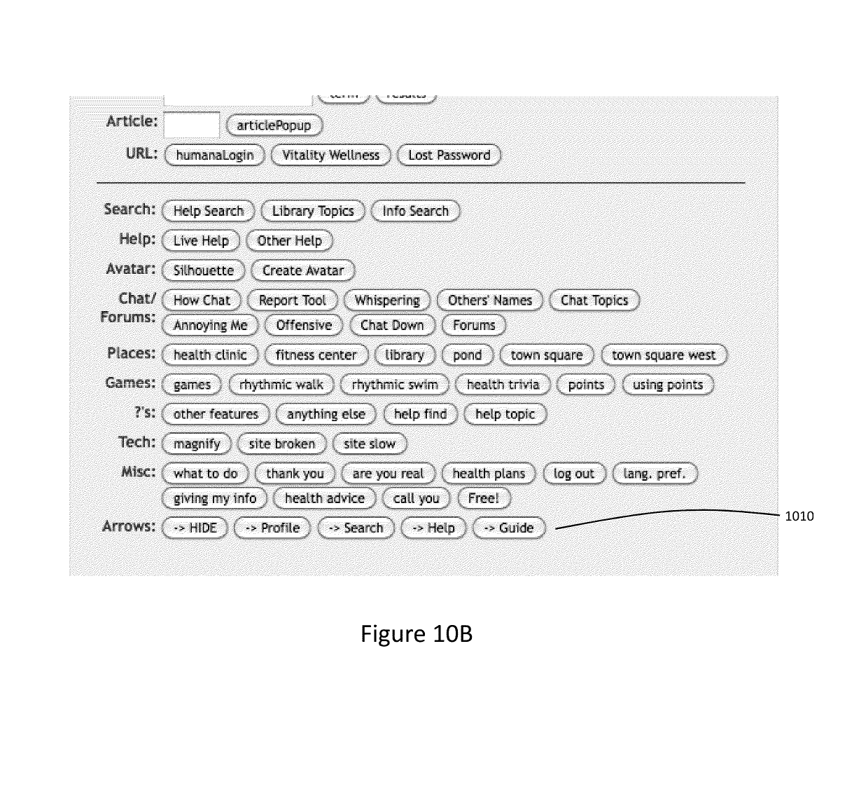

FIG. 10 illustrates a special control box available to CSRs of the online community from FIG. 9. The control box provides a number of tools for interacting with and helping members. The control box includes a text entry field 1000 for entering text-based messages. The text-based messages sent by the various users, i.e. the chat dialog, are displayed in the conversation box 1002. The search field 1004 enables a CSR to inject a search term into the receiving member's search field. Typing in text into the search field and pressing the “term” button injects the search term into the receiving member's search field. Pressing the “results” button executes the search on the receiving member's browser. Pressing the term button thus results in the communication of a click action (to position the cursor on the receiving member's search field) and a keycode action (entering the text in the receiving member's search field). Pressing the “result” button results in the communication of either a keycode action (with the carriage-return key being communicated to execute the search) or a click action (to click on the search button).

The article field 1006 enables the CSR to pop up an article on the receiving member's screen. Article field 1006 is thus an example of an action which allows a sending participant to share, with a receiving participant, a popup. In this case the popup includes a summary and a link to the article PDF. This is also an example of a text-box pop-up action.

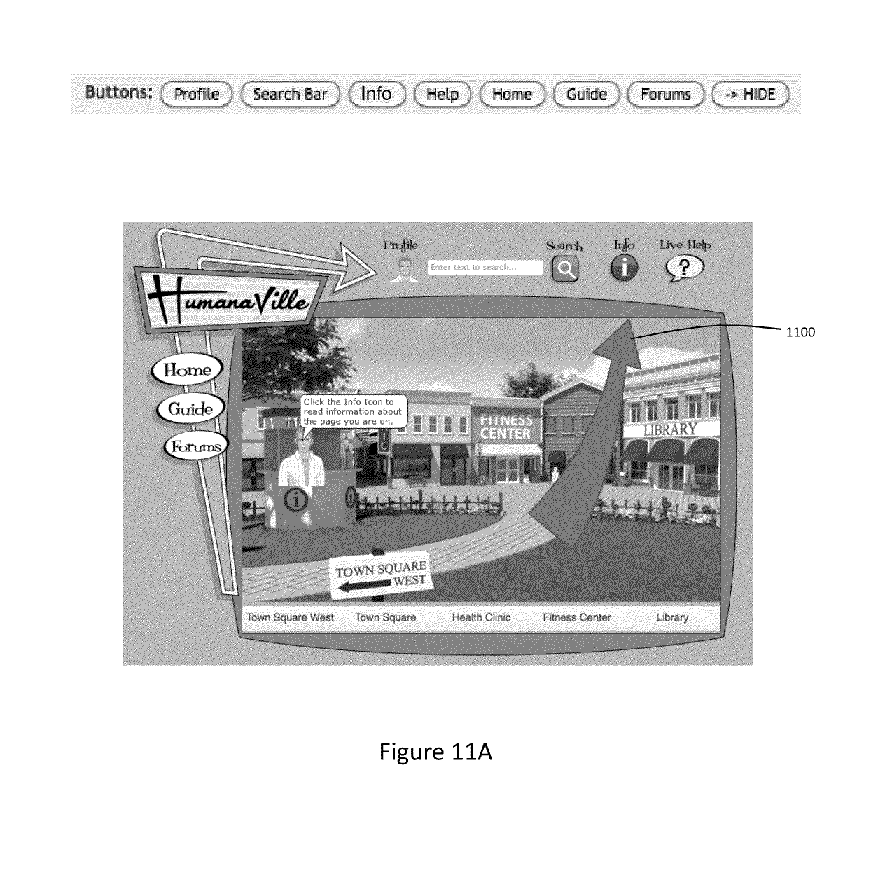

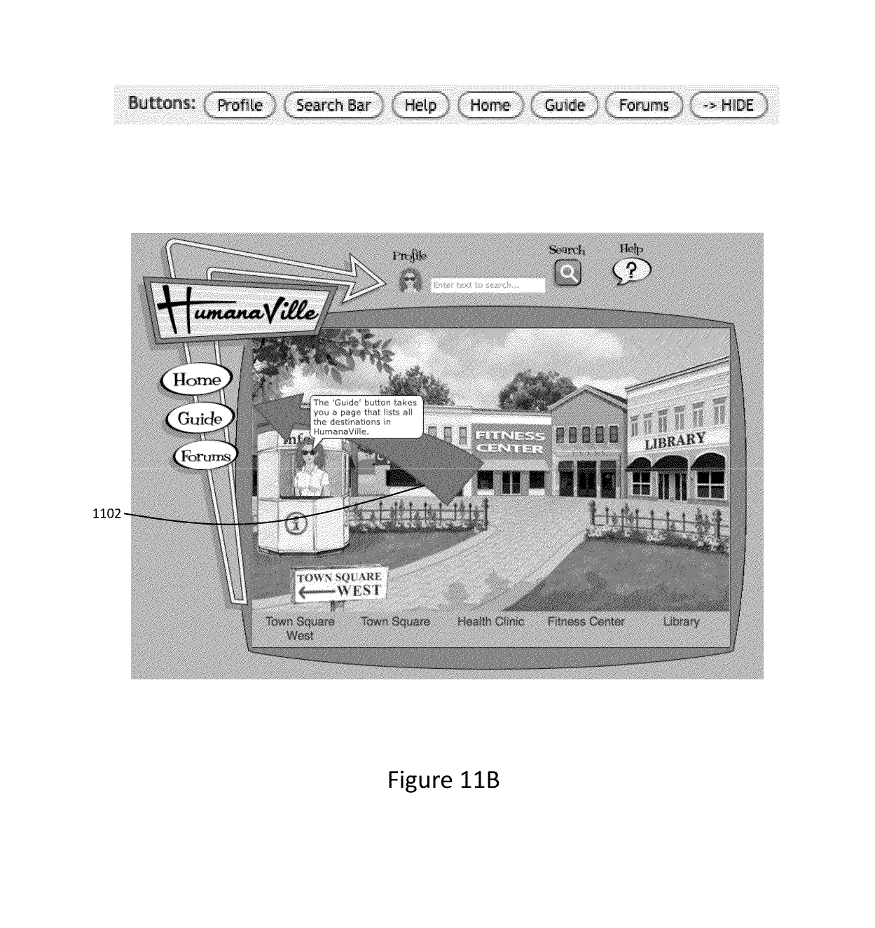

The URL field 1008 enables the CSR to share a URL with a receiving member. The URL can be displayed on the receiving member's screen. Alternatively, the shared URL may be loaded on a separate window on the receiving member's screen. Finally, arrow fields 1010 in FIG. 10B enable the CSR to draw arrows pointing to various elements of the virtual environment. For example, FIG. 11A illustrates arrow 1100 pointing to the “Info” icon. FIG. 11B illustrates a arrow 1102 pointing to the “Guide” button. Thus, the arrow fields 1010 are examples of preprogrammed sprite commands, where each button from the arrow fields 1010 automatically draws an arrow pointing to a particular item of interest.

Embodiments described herein also enable websites to enhance the user experience of members of social networking websites. As an illustrative example, embodiments described herein may be used to enhance the chatting system provided by the FACEBOOK website. For example, users can initiate chatting sessions, and use the share command to share photo albums, status updates, news and videos of interest, etc. The sprite command may be used to draw sprites on photos posted by members. For example, a group of participants may initiate a chatting session. One of the participants may then share the URL of a photo with all the participants. The participants can then discuss the photo, and add sprites to the photo. When any of the participants loses interest, he/she may choose to simply browse to a different page in the FACEBOOK website without disrupting the experience of any of the other participants.

Other illustrative websites may enable users to browse, visit, and use the services provided by the website, yet it may not enable users to initiate a chatting session unless the user logs in to the website. Alternatively, the website may prompt the user to login to the website as soon as the website loads, with the user given the option to log in as a guest. After a user has logged in, with a username or as a guest, the user may be sent notifications to encourage the user to chat with a plurality of participants. For example, whenever friends, contacts, or someone who may have previously chatted with the user comes online, the website may notify the user and may give the user the option to initiate a chatting session or the option to initiate a chatting session by sending a command message.

In other illustrative embodiments, websites may also track and notify the user of the number of users currently viewing the same web page, the number of users who have browsed the same web page at some point during the current session, the number of users who are currently logged in to the website, the number of users who have a particular item in their shopping cart, the number of users who are currently logged in who are friends of friends, the number of users who have browsed similar items, the number of users with similar shopping patterns, etc. These notifications may be displayed as a status message within the chat system interface, or within the web page, and may be used by the website to encourage users to initiate chat sessions with a wide range of users in order to share content, and to discuss products and other website content.

As presented above, illustrative embodiments may include shopping websites that provide an online customer service representative presence in order to help and guide online customers in their purchasing decision. For example, a user may initiate a chatting session with a customer representative in order to discuss a product that a user may be interested in. As described above, if a user was interested in purchasing a dress, the user may then initiate a chatting session with a customer representative by first sharing a URL of the dress web page, which would enable the user to sound off ideas regarding the dress.

It is to be understood that the detailed description of illustrative embodiments presented above are provided for illustrative purposes. The scope of the claims is not limited to these specific embodiments or examples. Therefore, various process limitations, elements, details, and uses can differ from those just described, or be expanded on or implemented using technologies not yet commercially viable, and yet still be within the inventive concepts of the present disclosure. The scope of the invention is determined by the following claims and their legal equivalents.

What is claimed is:

1. A system for enabling interactive communications between participants, the system comprising:
at least one web page associated with a website;
a first web-browser client corresponding to a first participant, the first web-browser client configured to access the website and to receive computer instructions from a first participant;
a second web-browser client corresponding to a second participant, the second web-browser client configured to access the website and to receive computer instructions from a second participant;
a synchronous communication channel between the first browser client and the second browser client, wherein the synchronous communication channel is configured to enable near real-time communications between the first participant and the second participant,
a spontaneous transmit message transmitted from the first web-browser client, wherein the spontaneous transmit message is generated by the first participant that is accessing the same website as the second participant;
the spontaneous transmit message communicated from the first web-browser client to the second web-browser client using the synchronous communications channel; and
the spontaneous transmit message received by the second browser client.

2. The system of claim 1, the system further comprising:
a web server configured to host the website, wherein the web server is configured to mediate the synchronous communications channel between the first web-browser client and the second web-browser client.

3. The system of claim 1, wherein the spontaneous transmit message further comprises a share message that is configured to communicate a URL of the web page displayed on the first web-browser client to the second web-browser client.

4. The system of claim 1, wherein the spontaneous transmit message further comprises a sprite message that is configured to draw a sprite at a set of coordinates on a first web page displayed on the first web-browser client and draw the sprite at the set of coordinates on a second web page displayed on the second web-browser client.

5. The system of claim 1, wherein the spontaneous transmit message comprises a click message that is configured to execute a click operation at set of coordinates on the web page displayed on the second web-browser client.

6. The system of claim 1, wherein the spontaneous transmit message comprises a keystroke message that is configured to inject a series of keycodes into a text field on the web page displayed on the second web-browser client.

7. The system of claim 1, wherein the spontaneous receive message includes at least one on of:
a share message that is configured to communicate a URL of the web page displayed on the first web-browser client to the second web-browser client,
a sprite message that is configured to draw a sprite at a set of coordinates on a first web page displayed on the first web-browser client and draw the sprite at the set of coordinates on a second web page displayed on the second web-browser client,
a click message that is configured to execute a click operation at a set of coordinates on the web page displayed on the second web-browser client,
a keystroke message that is configured to inject a series of keystrokes into a text field on the web page displayed on the second web-browser client.

8. A system for enabling interactive communications between participants, the system comprising:
at least one web page associated with a website;
a first web-browser client corresponding to a first participant, the first web-browser client configured to access the website and to receive computer instructions from a first participant;
a second web-browser client corresponding to a second participant, the second web-browser client configured to access the website and to receive computer instructions from a second participant;
a means for synchronous communication between the first browser client and the second browser client;
a spontaneous transmit message from the first web-browser client, wherein the spontaneous transmit message is generated by the first participant that is accessing the same website as the second participant;
the spontaneous transmit message communicated from the first web-browser client to the second web-browser client using the synchronous communications channel; and
a means for receiving the spontaneous transmit message with the second web-browser client.

9. The system of claim 8, the system further comprising:
a means for hosting the website, wherein the hosting means mediates the synchronous communications channel between the first web-browser client and the second web-browser client.

10. The system of claim 8, wherein the spontaneous transmit message further comprises a share message with means for communicating a URL of the web page displayed on the first web-browser client to the second web-browser client.

11. The system of claim 8, wherein the spontaneous transmit message further comprises a sprite message with means for drawing a sprite at a set of coordinates on a first web page displayed on the first web-browser client and drawing the sprite at the set of coordinates on a second web page displayed on the second web-browser client.

12. The system of claim 8, wherein the spontaneous transmit message comprises a click message with means for executing a click operation at set of coordinates on the web page displayed on the second web-browser client.

13. The system of claim 8, wherein the spontaneous transmit message comprises a keystroke message means for injecting a series of keycodes into a text field on the web page displayed on the second web-browser client.

14. The system of claim 8, wherein the spontaneous receive message includes at least one on of:
a share message with means for communicating a URL of the web page displayed on the first web-browser client to the second web-browser client,
a sprite message with means for drawing a sprite at a set of coordinates on a first web page displayed on the first web-browser client and draw the sprite at the set of coordinates on a second web page displayed on the second web-browser client,
a click message with means for executing a click operation at a set of coordinates on the web page displayed on the second web-browser client,
a keystroke message with means for injecting a series of keystrokes on a text field displayed on the web page displayed on the second web-browser client.

15. A computer-implemented method, comprising the steps of:
receiving a command via a chat system associated with a website, the command created by a first participant viewing a first web page of the website on a first browser, the command received through a synchronous communication channel associated with the chat system;
communicating the command to a second browser viewing a second web page of the website on the second browser, the command sent through the synchronous communication channel;
receiving the command at the second browser;
executing the command on the second browser, wherein the command results in an action being performed outside of an client interface of the chat system on the second browser.

16. The method of claim 15, wherein the action includes loading a URL of a portion of the first web page on the second browser.

17. The method of claim 15, wherein the action includes drawing a sprite at a set of coordinates on the second web page displayed on the second browser.

18. The method of claim 15, wherein the action includes performing a clicking operation at a set of coordinates on the second web page displayed on the second browser.

19. The method of claim 18, wherein the clicking operation includes a mouse dragging operation, a left mouse click, a right mouse click, a middle mouse click, and a scrolling operation.

20. The method of claim 15, wherein the action includes injecting a series of keycodes into a text field on the second web page displayed on the second browser.
